(19) United States
(12) Patent Application Publication
(10) Pub. No.: US 2010/0299268 A1
(43) Pub. Date: Nov. 25, 2010

(54) FRAMEWORK FOR SHARED PROCUREMENT SERVICES

(75) Inventors: Suman Guha, Fremont, CA (US); Margaret Lloyd, Menlo Park, CA (US); Seth Stafford, San Carlos, CA (US); Lee-Hian Quek, Foster City, CA (US); Tom David Anthony, Castro Valley, CA (US); David Scott Merrill, Palo Alto, CA (US); Nigel King, San Mateo, CA (US); Kim Elizabeth Powell, Niwot, CO (US)

Correspondence Address: TOWNSEND AND TOWNSEND AND CREW LLP/ORACLE, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/469,396

(22) Filed: May 20, 2009

(51) Int. Cl. G06Q 30/00; G06Q 10/00

(52) U.S. Cl. 705/80; 705/7; 705/26

(57) ABSTRACT

Techniques for supporting shared procurement services in an enterprise application. According to one set of embodiments, associations between procurement service providers and procurement clients are stored, where the associations represent outsourcing relationships between these entities in the operational structure of an enterprise. The associations are then used by the application to facilitate the management of procurement-related content and the processing of procurement transactions. In one embodiment, the associations enable procurement-related content to be created/managed centrally by a procurement service provider and then made accessible to procurement clients serviced by the procurement service provider. In another embodiment, a rules-driven mechanism is provided for routing procurement requisitions from procurement clients to associated procurement service providers for processing.

### CROSS-REFERENCES TO RELATED APPLICATIONS

The present application is related to commonly-owned U.S. patent application No. ______ (Attorney Docket No. 021756-061600US), filed concurrently with the present application and entitled “RULES DRIVEN FILTERING OF SERVICE REQUESTS FOR SHARED PROCUREMENT SERVICES,” the entire contents of which are incorporated herein by reference for all purposes.

### BACKGROUND OF THE INVENTION

Embodiments of the present invention relate to enterprise applications, and more particularly relate to techniques for supporting shared procurement services in an enterprise application.

In recent years, many enterprises have moved toward a shared services model for structuring their business operations. In a shared services model, one or more business operations (e.g., payables payments, payroll processing, procurement, etc.) are consolidated in specific business units in an enterprise. The business units may then expose these consolidated business functions as services that are provisioned to (and thus shared by) other business units in the enterprise. For example, an enterprise comprising a “US Administration” business unit and a “US Commercial” business unit may be structured such that all payroll processing is consolidated in the US Administration business unit. In this scenario, an outsourcing relationship may be created between the two business units that enables the US Administration business unit (known as a service provider) to perform the payroll processing business function on behalf of the US Commercial business unit (known as a client). By implementing a shared services model, enterprises can achieve higher economies of scale and greater business unit specialization, thereby improving operational efficiency and realization of business objectives.

Procurement is an example of a business operation that is well-suited to consolidation per a shared services model. As used herein, procurement refers to the acquisition of goods and/or services for the benefit of or use by entities in an enterprise. Procurement requisitions (e.g., requests to purchase raw materials, office supplies, capital equipment, etc.) are typically generated by many business units in an enterprise. However, the end-to-end procurement business process comprises a number of tasks that are difficult or inefficient to duplicate in each business unit. Accordingly, it is advantageous to establish procurement service providers (e.g., procurement business units) in an enterprise that are specifically adapted to perform some or all of these procurement tasks on behalf of procurement clients (e.g., requisition-generating, or “requisitioning,” business units) in the enterprise.

One challenge with implementing shared procurement services is that existing enterprise applications in the procurement field are not designed to support a shared services model. For example, while existing enterprise applications are capable of modeling an enterprise as a collection of business units, they generally cannot model the various outsourcing relationships that may exist between procurement service providers and procurement clients. As a result, existing enterprise applications cannot leverage these outsourcing relationships to streamline or otherwise facilitate the procurement process.

### BRIEF SUMMARY OF THE INVENTION

Embodiments of the present invention provide techniques for supporting shared procurement services in an enterprise application. According to one set of embodiments, associations between procurement service providers and procurement clients are stored, where the associations represent outsourcing relationships between these entities in the operational structure of an enterprise. The associations are then used by the application to facilitate the management of procurement-related content and the processing of procurement transactions. In one embodiment, the associations enable procurement-related content to be created/managed centrally by a procurement service provider and then made accessible to procurement clients serviced by the procurement service provider. In another embodiment, a rules-driven mechanism is provided for routing procurement requisitions from procurement clients to associated procurement service providers for processing.

According to one embodiment of the present invention, a method for supporting shared procurement services is provided. The method comprises storing, by a computer system, an association between a first entity and a second entity in an enterprise, where the association indicates that the first entity is configured to provide one or more procurement services to the second entity. The method further comprises storing, by the computer system, procurement-related content generated by the first entity. The procurement-related content is then made accessible to the second entity based on the association.

In one embodiment, the method above further comprises storing, by the computer system, an association between the first entity and a third entity in the enterprise, where the association between the first entity and the third entity indicates that the first entity is configured to provide one or more procurement services to the third entity. The procurement-related content is then made accessible to the third entity based on the association between the first entity and the third entity.

In one embodiment, the method above further comprises storing, by the computer system, an association between a third entity in the enterprise and the second entity, where the association between the third entity and the second entity indicates that the third entity is configured to provide one or more procurement services to the second entity, and storing, by the computer system, procurement-related content generated by the third entity. The procurement-related content generated by the third entity is then made accessible to the second entity based on the association between the third entity and the second entity.

In one embodiment, the first entity has a first procurement specialization and the third entity has a second procurement specialization different from the first procurement specialization.

In one embodiment, the first and second procurement specializations correspond to different commodities. In another embodiment, the first and second procurement specializations correspond to different geographic regions.

In one embodiment, the one or more procurement services include at least one of: supply base management, sourcing, catalog content management, agreement/contract management, and purchase order administration.

In one embodiment, the procurement-related content comprises a purchase agreement negotiated between the first entity and an external supplier. In a further embodiment, the purchase agreement determines whether purchase order administration is performed by the first entity on behalf of the second entity or by the second entity internally.

In one embodiment, the procurement-related content further comprises catalog content and guided templates for off-catalog requisitions.

According to another embodiment of the present invention, a system for supporting shared procurement services is provided. The system comprises a memory component configured to store an association between a first entity and a second entity in an enterprise, the association indicating that the first entity is configured to provide one or more procurement services to the second entity, and to store procurement-related content generated by the first entity. The system further comprises a processing component in communication with the memory component, where the processing component is configured to cause the procurement-related content to be made accessible to the second entity based on the association.

According to another embodiment of the present invention, a machine-readable medium having stored thereon program code executable by a processing component of a computer system is provided. The program code comprises code that causes the processing component to store an association between a first entity and a second entity in an enterprise, the association indicating that the first entity is configured to provide one or more procurement services to the second entity; code that causes the processing component to store procurement-related content generated by the first entity; and code that causes the processing component to make the procurement-related content accessible to the second entity based on the association.

A further understanding of the nature and advantages of the embodiments disclosed herein may be realized by reference to the remaining portions of the specification and the attached drawings.

### BRIEF DESCRIPTION OF THE DRAWINGS

FIG. 1 is a simplified block diagram illustrating an operational structure of an enterprise.

FIG. 2 is a flowchart illustrating steps that may be performed for supporting shared procurement services in accordance with an embodiment of the present invention.

FIG. 3 is an association table that may be generated in accordance with an embodiment of the present invention.

FIG. 4 is a screen display illustrating a user interface for assigning business functions to a business unit in accordance with an embodiment of the present invention.

FIG.5 is a screen display illustrating a user interface for defining associations between procurement service providers and procurement clients in accordance with an embodiment of the present invention.

FIG. 6 is a screen display illustrating a user interface for creating a purchase agreement in accordance with an embodiment of the present invention.

FIG. 7 is a screen display illustrating a user interface for selecting requisition items from a centrally-defined catalog in accordance with an embodiment of the present invention.

FIG. 8 is a screen display illustrating a guided template for creating an off-catalog requisition in accordance with an embodiment of the present invention.

FIG. 9 is a flowchart illustrating steps that may be performed for filtering procurement requisitions in accordance with an embodiment of the present invention.

FIG. 10 is a simplified block diagram illustrating a system environment that may be used in accordance with an embodiment of the present invention.

FIG. 11 is a simplified block diagram illustrating a computer system that may be used in accordance with an embodiment of the present invention.

### DETAILED DESCRIPTION OF THE INVENTION

In the following description, for the purposes of explanation, numerous details are set forth in order to provide an understanding of the present invention. It will be apparent, however, to one skilled in the art that the present invention may be practiced without some of these details.

Embodiments of the present invention provide a framework that enables an enterprise application to support shared procurement services. As used herein, an enterprise application is a software application that is used by an enterprise to automate or facilitate its business operations.

In one set of embodiments, the techniques described herein allow for the creation of associations between procurement service providers (e.g., procurement business units) and procurement clients (e.g., requisitioning business units) that model outsourcing relationships between these entities in the operational structure of an enterprise. An outsourcing relationship is a relationship in which a first entity (i.e., a service provider) provisions services to a second entity (i.e., a client) distinct from the first entity. In the context of a shared procurement model, a procurement service provider is configured to provision procurement services to (i.e., perform procurement tasks on behalf of) a procurement client.

The associations may then be used by the application to facilitate the management of procurement-related content and the processing of procurement transactions. In one embodiment, procurement-related content (i.e., data that is relevant to the procurement business process) may be created/managed centrally by a procurement service provider and then shared with one or more procurement clients serviced by the procurement service provider. In another embodiment, procurement requisitions generated by procurement clients may be automatically filtered based on the associations and a set of business rules to determine which procurement service providers should process the requisitions.

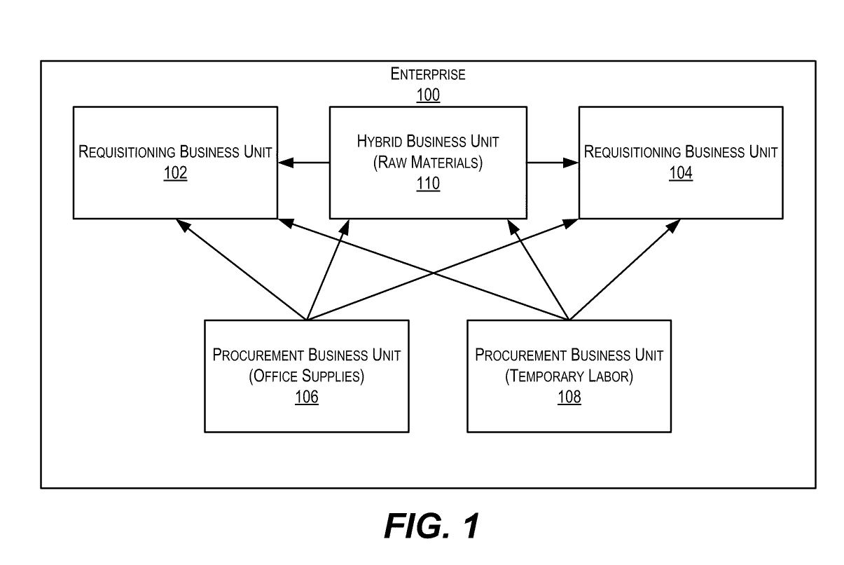

FIG. 1 is a simplified block diagram illustrating an enterprise 100 that is structured to make use of shared procurement services. For the purposes of the present disclosure, procurement refers to the acquisition of goods and/or services for the benefit of or use by entities in an enterprise. As shown, enterprise 100 includes a plurality of requisitioning business units 102, 104 and a plurality of procurement business units 106, 108. Requisitioning business units 102, 104 are entities in the enterprise that are configured to generate procurement requisitions, i.e., requests to purchase goods and/or services. Procurement business units 106, 108 are entities in the enterprise that are configured to perform one or more procurement tasks, such as supply base management, sourcing, catalog content management, agreement/contract management, purchase order administration, and the like.

By way of definition, supply base management refers to the process of identifying new suppliers of goods and/or services, evaluating existing suppliers, and running initiatives to improve supplier performance in a proactive way. Sourcing refers to the process of identifying an optimum source for goods/services from a supply base. This typically involves asking for proposals from potential suppliers, evaluating the bids, and then placing awards for orders or agreements based on the evaluation. Purchase order administration refers to the process of raising purchase orders for suppliers in response to requisitions for goods/services, communicating orders to the suppliers, ensuring their acknowledgment, handling queries on the orders from suppliers and requesters, and ensuring satisfactory fulfillment of the orders and their timely settlement. Catalog content management refers to creating and managing electronic catalogs based on pre-negotiated pricing agreements. The electronic catalogs are used by requisitioning business units to select requisition items. And agreement/contract management refers to the process of authoring and maintaining purchase agreements with suppliers with pre-negotiated terms and conditions including pricing of goods and/or services to be acquired over the period of the agreement.

The arrows in FIG. 1 indicate that business units 102, 104, 106, 108 are involved in procurement outsourcing relationships. Specifically, the arrows from procurement business unit 106 to requisitioning business units 102, 104 indicate that procurement business unit 106 is configured to perform one or more procurement tasks on behalf of requisitioning business units 102, 104. Similarly, the arrows from procurement business unit 108 to requisitioning business units 102, 104 indicate that procurement business unit 108 is configured to perform one or more procurement tasks on behalf of requisitioning business units 102, 104. Thus, procurement business units 106, 108 may be considered procurement service providers (i.e., entities configured to provision procurement services to others), and requisitioning business units 102, 104 may be considered procurement clients (i.e., entities configured to consume procurement services from others).

In one set of embodiments, procurement business units 106, 108 may each have a procurement specialization. When a procurement service provider is said to have a procurement specialization, that procurement service provider is particularly adapted to procure goods and/or services with respect to a specific domain, such as a specific commodity, a specific geographic region, etc. Examples of different commodities include office supplies, computer equipment, and the like. Examples of different geographic regions include North America, Canada, Mexico, Asia/Pacific, and the like. In the example of FIG. 1, procurement business unit 106 is specialized to procure office supplies and procurement business unit 108 is specialized to procure temporary labor. Requisitioning business units 102, 104 may take advantage of these specializations by relying on procurement business unit 106 to provide procurement services that specifically pertain to office supplies, and by relying on procurement business unit 108 to provide procurement services that specifically pertain to temporary labor.

As shown, enterprise 100 may also include one or more hybrid business units 1 10. For the purposes of the present disclosure, a hybrid business unit is an entity in an enterprise that is configured to act as both a procurement service provider and a procurement client. For example, in FIG. 1, hybrid business unit 110 is configured to both (1) provide procurement services to requisitioning business units 102, 104 that pertain to raw materials (110's procurement specialization) and (2) consume procurement services provided by procurement business units 106,108 that pertain to office supplies and temporary labor (106 and 108's respective specializations). In some cases, a hybrid business unit may also handle some portion of its procurement needs internally. For example, hybrid business unit 110 may internally process procurement requisitions that pertain to raw materials.

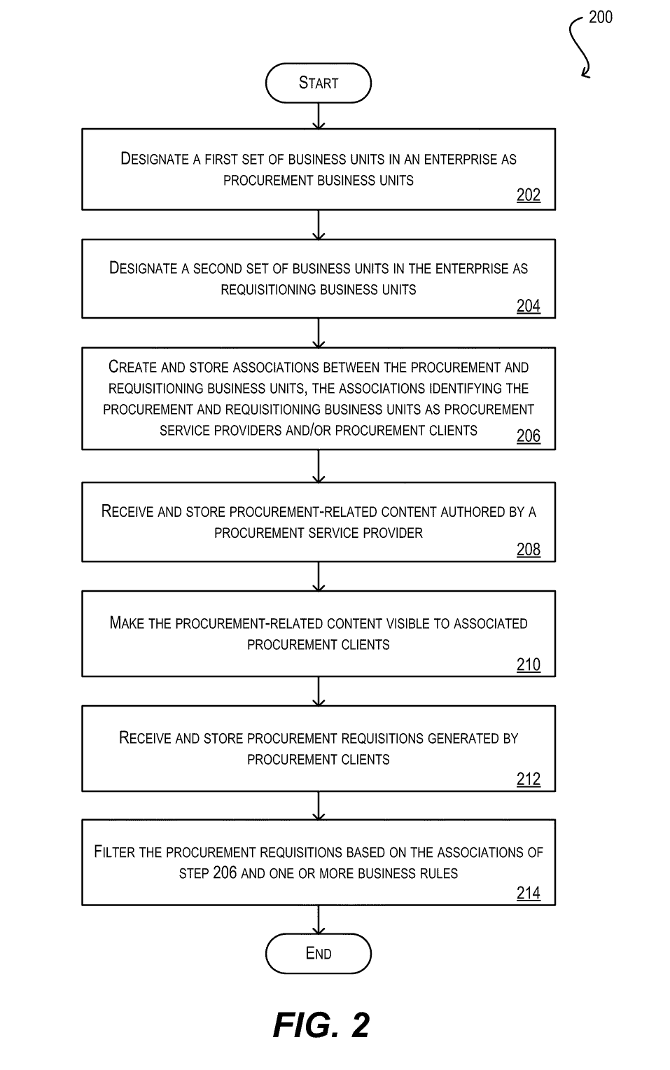

FIG. 2 is a flowchart 200 illustrating steps that may be performed for supporting shared procurement services in an enterprise application according to an embodiment of the present invention. In various embodiments, the processing of flowchart 200 may be implemented in software, hardware, or combinations thereof. As software, the processing of flowchart 200 may be encoded as program code stored on a machine-readable storage medium.

At step 202, a first set of business units in an enterprise are designated as procurement business units within the application. Generally speaking, the first set of business units will comprise one or more business units that perform (or are intended to perform) procurement tasks in the operational structure of the enterprise. For example, the first set of business units may comprise procurement business units 106, 108 in enterprise 100 of FIG. 1. By designating these business units as procurement business units, their operational roles may be formally defined in the application. Further, these designations enable business units in the first set to carry out various procurement tasks via the application. Procurement tasks are any tasks that are performed to facilitate the acquisition of goods and/or services in an enterprise. For example, by designating a “US Operations” business unit as a procurement business unit, users in the US Operations business unit may be enabled to manage supplier lists, create purchase agreements, process procurement requisitions, and the like via the application.

At step 204, a second set of business units in the enterprise are designated as requisitioning business units within the application. Generally speaking, the second set of business units will comprise one or more business units that generate (or are intended to generate) procurement requisitions in the operational structure of the enterprise. For example, the second set of business units may comprise requisitioning business units 102, 104 in enterprise 100 of FIG. 1. By designating these business units as requisitioning business units, their operational roles may be formally defined in the application. Further, these designations enable the business units in the second plurality to generate procurement requisitions via the application.

Although not shown in flowchart 200, in some embodiments a third set of business units in the enterprise may be designated as both procurement and requisitioning business units within the application. For example, the third set of business units may comprise a hybrid business unit such as hybrid business unit 110 of FIG. 1.

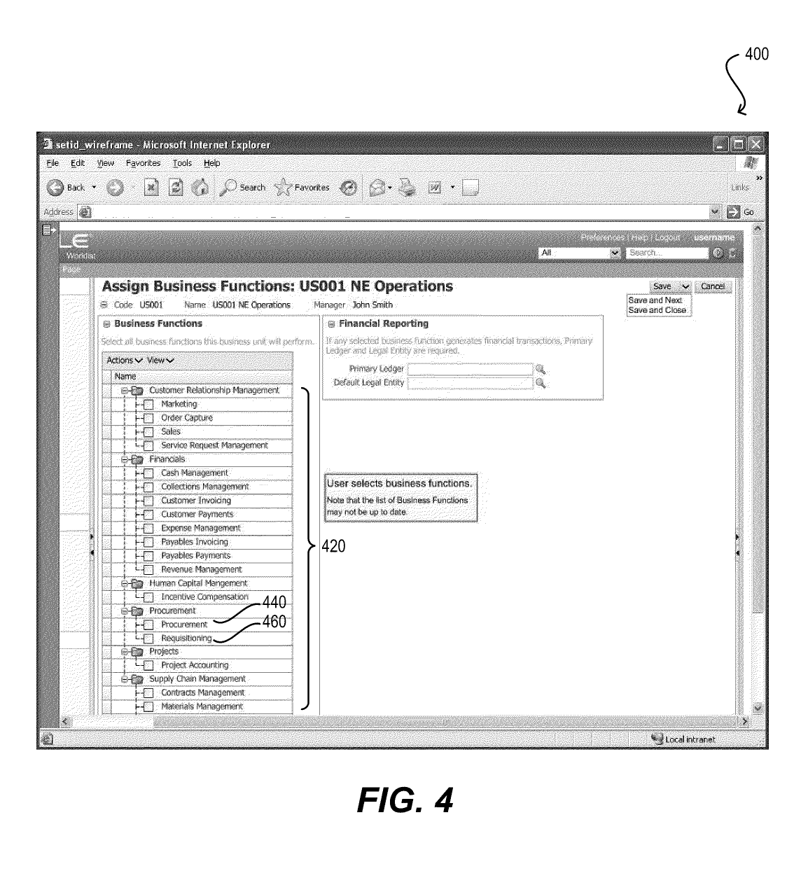

In one set of embodiments, designating a business unit as a procurement business unit or a requisitioning business unit per steps 202 and 204 comprises assigning a procurement business function or a requisitioning business function to the business unit via a user interface of the application. An example of such a user interface 400 is depicted in FIG. 4. As shown, user interface 400 displays, in the context of a particular business unit (e.g., “US001 NE Operations”), a list 420 of selectable business functions representing operations that may be performed within the application. One or more business functions in the list may be selected and assigned to the business unit “US001 NE Operations,” thereby enabling the business unit to perform the operations corresponding to the selected business functions.

For example, if the US001 NE Operations business unit is configured to perform procurement tasks in the operational structure of an enterprise, procurement business function 420 may be selected and assigned to US001 NE Operations. Alternatively, if US001 NE Operations is configured to generate procurement requisitions in the operational structure of the enterprise, requisitioning business function 440 may be selected and assigned to US001 NE Operations. In cases where US001 NE Operations is configured to act as both a procurement and a requisitioning business unit (e.g., hybrid business unit 110 of FIG. 1), both functions 420 and 440 may be selected and assigned to US001 NE Operations. Generally speaking, user interface 400 will be presented to an administrator or some other entity in the enterprise that is familiar with its operational structure and is responsible for modeling that structure by assigning business functions to business units within the application.

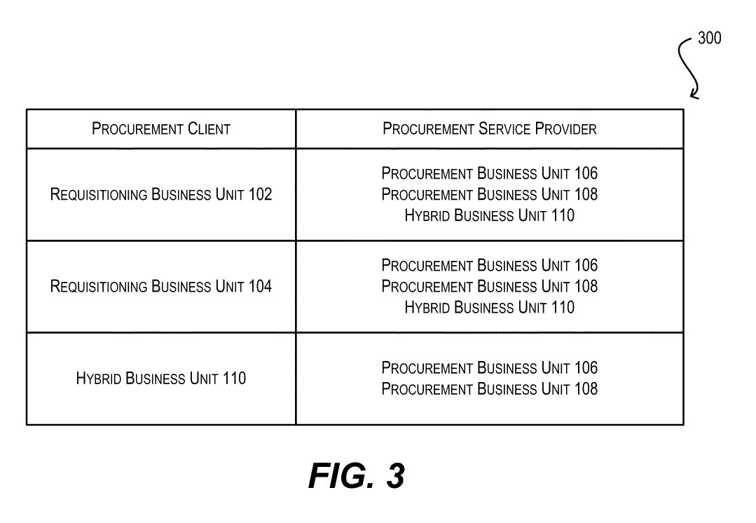

Returning to FIG. 2, once business units in the enterprise have been designated as procurement and/or requisitioning business units, associations between the business units are created and stored (step 206). In various embodiments, these associations reflect outsourcing relationships between the business units in the operational structure of the enterprise. Thus, the stored associations represent a model of the enterprise's shared procurement operations. For example, FIG. 3 illustrates an association table 300 that may be created and stored with respect to enterprise 100 of FIG. 1 as a result of the processing in step 206. As shown, table 300 includes a “procurement client” column identifying business units in enterprise 100 configured to consume procurement services and a “procurement service provider” column identifying business units in enterprise 100 configured to provide procurement services. Each row of table 300 identifies one or more associations between one or more procurement clients identified by the row and one or more service providers identified by the row. The various associations stored in table 300 reflect the outsourcing relationships between business units 102, 104, 106, 108, 110 depicted in FIG. 1.

In one set of embodiments, the associations created at step 206 may comprise many-to-many mappings between procurement clients and procurement service providers. For example table 300 includes associations mapping requisitioning business unit 102 (procurement client) to procurement business units 106, 108 and hybrid business unit 110 (procurement service providers). Similarly, table 300 includes associations mapping procurement business unit 106 (procurement service provider) to requisitioning/hybrid business units 102, 104 and hybrid business unit 110 (procurement clients). Accordingly, embodiments of the present invention are capable of modeling operational structures in which one-to-many, many-to-one, or many-to-many outsourcing relationships exist between clients and service providers. This scenario is common in the shared procurement services context, since one procurement client may rely on a number of different specialized procurement service providers (e.g., service provider for office supplies, service provider for raw materials, etc.) to satisfy its procurement needs.

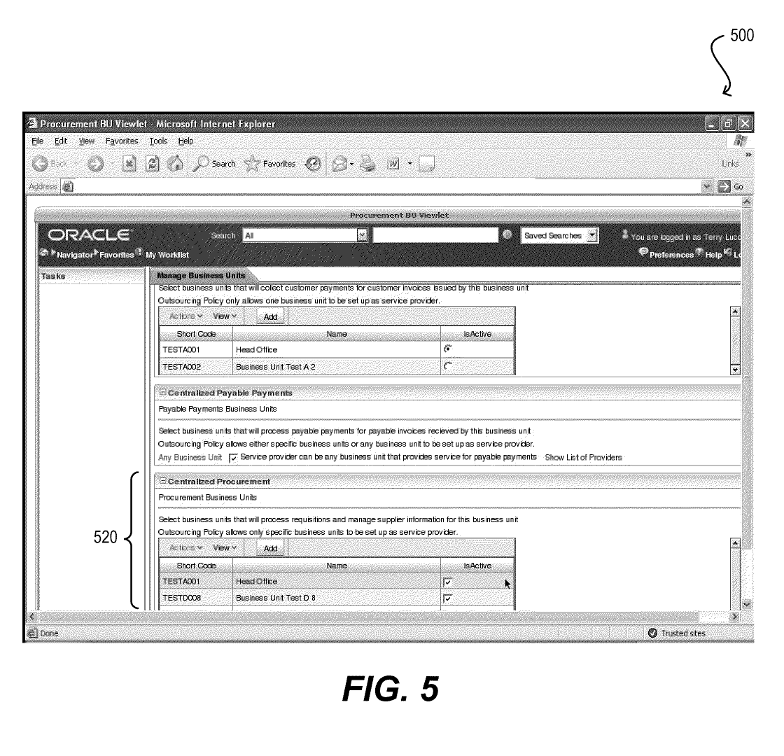

FIG. 5 illustrates a user interface 500 for creating associations per step 206 of FIG. 2. As shown, user interface 500 displays, in the context of a particular requisitioning business unit, a section 520 referred to as “Centralized Procurement.” Section 520 enables a user to specify procurement service providers (e.g., procurement business units) that should be associated with the current requisitioning business unit. Generally speaking, user interface 500 will be presented to an administrator or some other entity in the enterprise that is responsible for structuring associations between business units.

Once associations have been created and stored per step 206 of FIG. 2, these associations may be used by the application to facilitate aspects of a shared procurement workflow. For example, at step 208, the application receives and stores procurement-related content (e.g., purchase agreements, catalog content, guided templates for off-catalog requisitions, approved supplier lists, etc.) that is authored by a procurement service provider. As used herein, procurement-related content refers to any type of information that may be relevant to procurement. The procurement-related content authored by a procurement service provider is then made visible to procurement clients that are associated with (and thus serviced by) the service provider (step 210). In one set of embodiments, a single copy of procurement-related content is created/managed centrally by the procurement service provider, and that single copy is made accessible to associated procurement clients. Thus, the procurement-related content does not need to replicated at each associated procurement client.

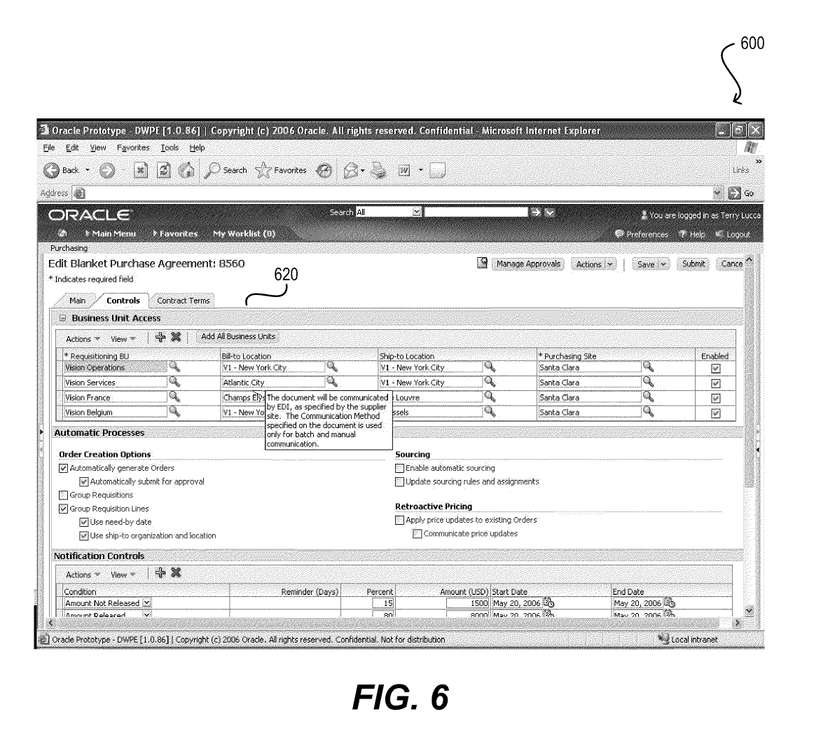

To enable the authoring of procurement-related content by a procurement service provider per step 208, one or more user interfaces may be generated and presented to end-users in the procurement service provider. For example, FIG. 6 illustrates a user interface 600 for defining a purchase agreement. Generally speaking, a purchase agreement is a contract negotiated between a procurement business unit in an enterprise and a supplier external to the enterprise (i.e., an external supplier) for purchasing goods or services from the external supplier. The purchase agreement will typically specify the items (or types of items) that may be purchased, along with various purchase terms such as unit prices, purchasing site, ship-to location, bill-to location, etc.

As shown, user interface 600 includes a table 620 referred to as “Business Unit Access.” Table 620 identifies which procurement clients associated with the current procurement service provider (per the associations created at step 206) will be able to access the purchase agreement being defined (e.g., purchase agreement “8560”). Thus, by adding or removing rows from table 620, the procurement service provider may control how purchase agreement 8560 is shared with its associated client base. In the example of FIG. 6, purchase agreement 8560 will be accessible to requisitioning business units “Vision Operations,” “Vision Services,” “Vision France,” and “Vision Belgium.”

Although not shown in FIG. 6, in one embodiment table 620 may include, for each row, one or more user interface elements that indicate whether some subset of the procurement tasks typically handled by the procurement service provider will instead be handled by the procurement client. For example, with respect to the first row of table 620, an “Execute Locally?” checkbox may be provided that (1) when checked, indicates that purchase order administration for requisitions created using purchase agreement 8560 will be processed in-house by Vision Operations, and (2) when unchecked, indicates that such purchase order administration will be processed externally by the current procurement service provider. Through this mechanism, the procurement service provider may control the scope of procurement services provided to a particular procurement client.

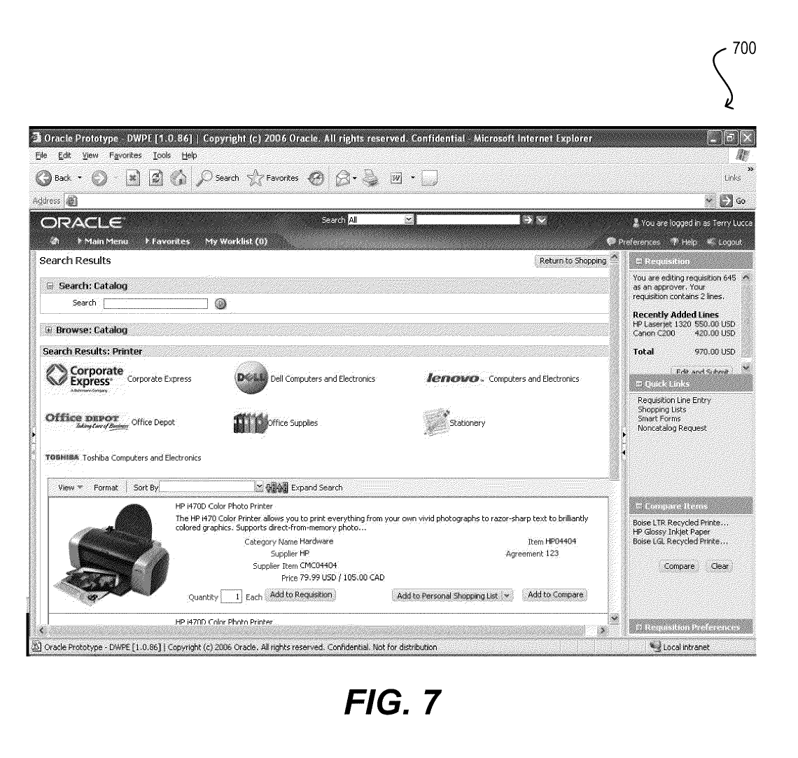

To enable the viewing of procurement-related content by a procurement client per step 210 of FIG. 2, one or more user interfaces may be generated and presented to end-users in the procurement client. Generally speaking, such procurement-related content will be made available to the procurement client in the context of a requisition creation flow. For example, FIG. 7 illustrates a user interface 700 for browsing, by a user in a procurement client, catalog content for generating a procurement requisition. The displayed content is based on a purchase agreement “Agreement 123” that is centrally defined/maintained by an associated procurement service provider. Agreement 123 is an example of procurement-related content that may have been authored by the procurement service provider per step 208 of FIG. 2. In various embodiments, the user may select one or more items in the catalog and generate a procurement requisition for those items.

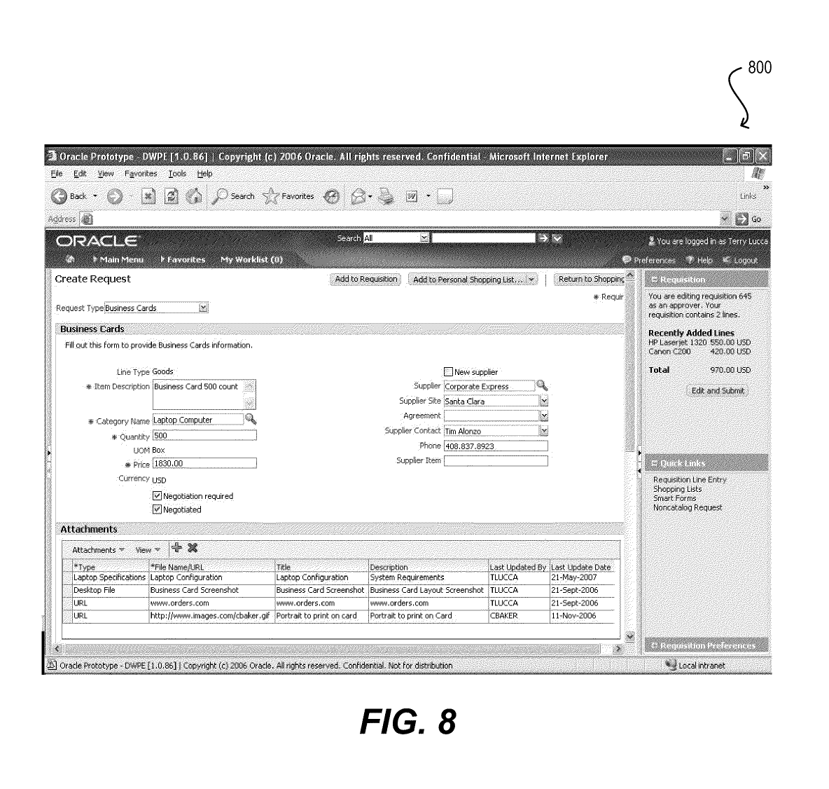

As another example, FIG. 8 illustrates a user interface 800 for creating, by a user in a procurement client, an off-catalog requisition for business cards. The fields displayed in user interface 800 are part of a template is that is centrally defined by an associated procurement service provider and then made available to the procurement client.

Returning to FIG. 2, once procurement-related content is authored by procurement service providers and made accessible to associated procurement clients per steps 208, 210, procurement requisitions generated by the procurement clients are received and stored (step 212). The procurement requisitions are then filtered to determine which procurement service provider should process a particular procurement requisition (step 214). In one set of embodiments, this determination may be based upon the associations created at step 206. For example, a requisition generated by a requisitioning business unit may only by processed by a procurement business unit that is associated with (and is therefore configured to provision services to) the requisitioning business unit.

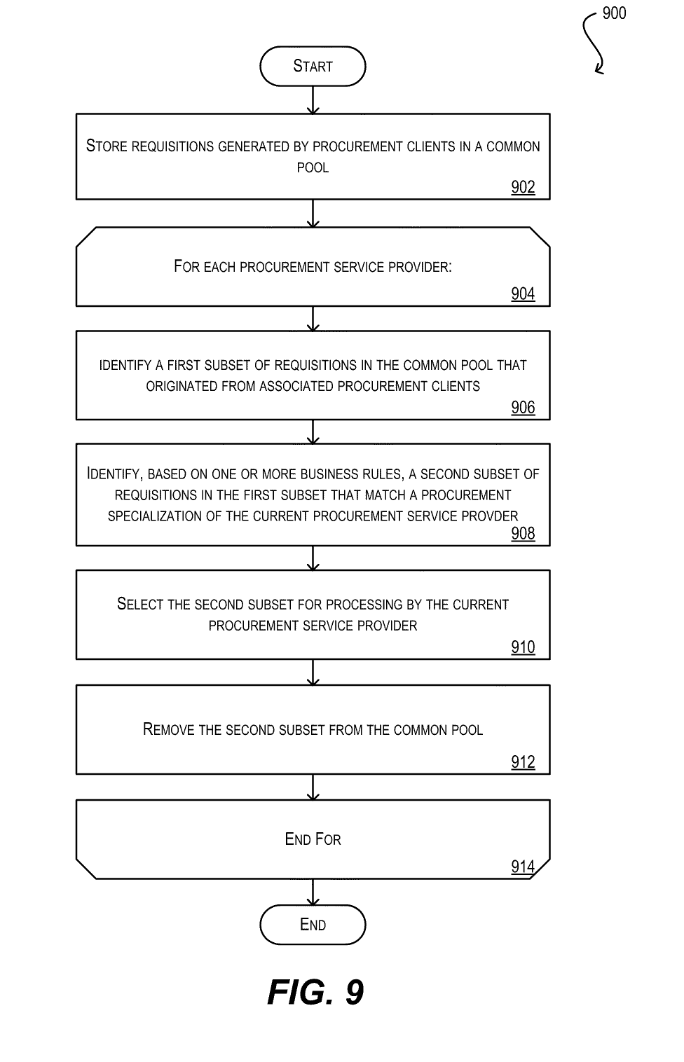

In a further set of embodiments, this determination may also be based on a set of business rules that take into consideration the procurement specializations of various procurement service providers. For example, in enterprise 100 of FIG. 1, requisitioning business unit 102 consumes procurement services from procurement business unit 106 with respect to a first specialization (office supplies) and consumes procurement services from procurement business unit 108 with respect to a second specialization (temporary labor). To ensure that a requisition generated by requisitioning business unit 102 is processed by the most appropriate procurement business unit, one or more business rules may be applied to the requisition that matches the requisition to a particular specialization (e.g., either office supplies or temporary labor). The requisition may then be picked up and processed by a procurement business unit having that specialization. This rules-driven filtering process is discussed in greater detail with respect to FIG. 9 below.

It should be appreciated that the specific steps illustrated in FIG. 2 provide a particular method for supporting shared procurement services in an enterprise application according to an embodiment of the present invention. Other sequences of steps may also be performed according to alternative embodiments. For example, individual steps illustrated in FIG. 2 may include multiple sub-steps that may be performed in various sequences as appropriate to the individual step. Further, additional steps may be added, or existing steps may be removed, depending on the particular application. One of ordinary skill in the art would recognize many variations, modifications, and alternatives.

FIG. 9 is a flowchart 900 illustrating steps that may be performed for filtering procurement requisitions according to an embodiment of the present invention. In one set of embodiments, the processing of flowchart 900 may be performed as part of steps 212, 214 of FIG. 2.

At step 902, procurement requisitions generated by procurement clients in an enterprise are stored in a common pool. In various embodiments, the procurement clients are business units in the enterprise that have been associated with procurement service providers per step 206 of FIG. 2. Typically, procurement requisitions stored in the common pool will comprise requisitions that have been approved for processing by, for example, a requisitions manager in the originating procurement client.

At step 904, an iterative process is initiated to determine, for each procurement service provider in the enterprise, whether the common pool includes any procurement requisitions that should be processed by that service provider. For example, at step 906, the common pool is analyzed to identify a first subset of requisitions in the pool that originate from (e.g., were generated by) procurement clients associated with a current procurement service provider. If such a first subset is found, the first subset is then analyzed to identify a second subset of requisitions (in the first subset) that match a procurement specialization of the current service provider (step 908).

In one set of embodiments, the processing of step 908 is based on a set of business rules that is defined for each procurement service provider and that matches keywords or key values relevant to the service provider's procurement specialization to attributes in a procurement requisition. For example, if a procurement service provider is specialized to procure office supplies, the set of business rules defined for that service provider might include a rule that looks for the term “office supplies” in a “requisition type” attribute of a procurement requisition. As another example, if a procurement service provider is specialized to procure items in the United States, the set of business rules defined for that service provider might include a rule that looks for a U.S. zip code in a “ship-to location” or “ship-from location” attribute of a procurement requisition. If a match is found, the requisition is selected for processing by the procurement service provider at step 910. In this manner, procurement requisitions can be automatically routed to the most appropriate procurement service providers based on their respective specializations.

In one set of embodiments, the business rules for a procurement service provider may be defined declaratively (rather than programmatically) and stored as metadata. Thus, the business rules may be created and modified by business analysts in the enterprise that may not have programming expertise.

Once procurement requisitions have been selected for processing by a current procurement service provider at step 910, the selected requisitions may be removed from the common pool (step 912). The iterative process then restarts at step 904 for additional procurement service providers in the enterprise. Although steps 906-910 are shown in FIG. 6 as occurring in a loop, it should be appreciated that these steps do not need to be repeated for each service provider in a strict sequence. In one set of embodiments, the processing of steps 906-910 may be initiated for each procurement service provider at predetermined time intervals defined for that service provider. For example, the processing of steps 906-910 may be initiated by a batch program. In alternative embodiments, the processing of steps 906-910 may initiated for each procurement service provider manually (i.e., by an administrator or some other individual in the organization).

In some situations, one or more procurement requisitions in the common pool may not be selected by any procurement service provider per steps 906-910. In these cases, the unselected requisitions may be assigned to a default service provider for processing. In one set of embodiments, a default service provider may be identified for each requisitioning business unit, where the default service provider is selected from the group of service providers associated with that requisitioning business unit. In other embodiments, a single default service provider may be identified that applies to all requisitioning business units.

It should be appreciated that the specific steps illustrated in FIG. 9 provide a particular method for filtering procurement requisitions according to an embodiment of the present invention. Other sequences of steps may also be performed according to alternative embodiments. For example, individual steps illustrated in FIG. 9 may include multiple sub-steps that may be performed in various sequences as appropriate to the individual step. Further, additional steps may be added, or existing steps may be removed, depending on the particular application. One of ordinary skill in the art would recognize many variations, modifications, and alternatives.

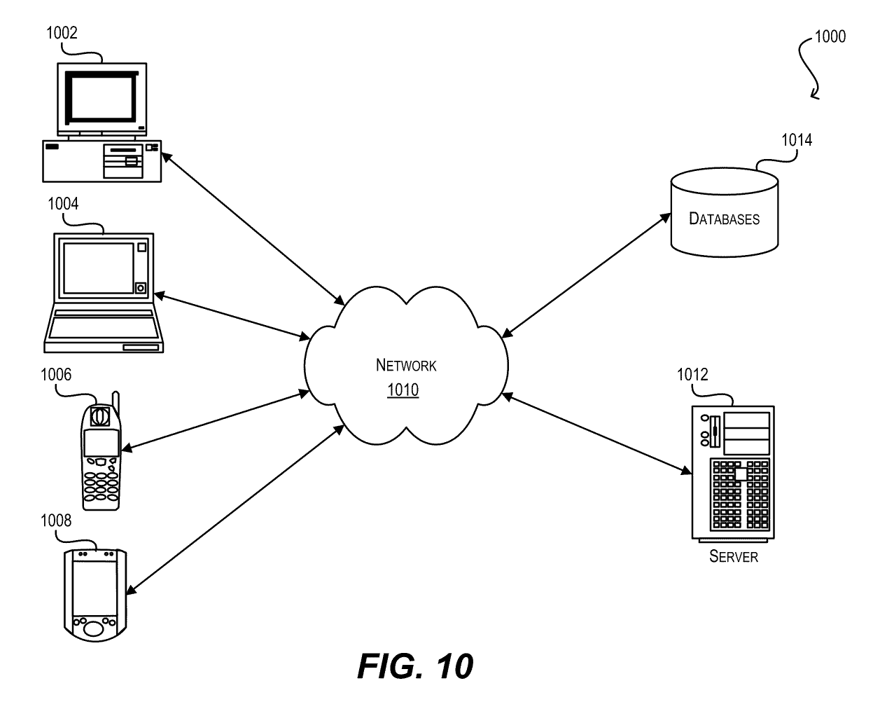

FIG. 10 is a simplified block diagram illustrating components of a system environment 1000 that may be used in accordance with an embodiment of the present invention. As shown, system environment 1000 includes one or more client computing devices 1002, 1004, 1006, 1008, which are configured to operate a client application such as web browser, proprietary client (e.g., Oracle Forms), and/or the like. In various embodiments, client computing devices 1002, 1004, 1006, 1008 are used to interact with the enterprise application described in the foregoing disclosure. For example, client computing devices 1002, 1004, 1006, 1008 may be used execute procurement and/or requisitioning-related tasks within the application, such as via user interfaces 400, 500, 600, 700, 800 of FIGS. 4-8.

Client computing devices 1002, 1004, 1006, 1008 may be general purpose personal computers (including, e.g., personal computers and/or laptop computers running various versions of Microsoft Windows and/or Apple Macintosh operating systems), cell phones or PDAs (running software such as Microsoft Windows Mobile and being Internet, e-mail, SMS, Blackberry, or other communication protocol enabled), and/or workstation computers running any of a variety of commercially-available UNIX or UNIX-like operating systems (including without limitation the variety of GNU/Linux operating systems). Alternatively, client computing devices 1002, 1004, 1006, 1008 may be any other electronic device capable of communicating over a network (e.g., network 1010 described below). Although system environment 1000 is shown with four client computing devices, any number of client computing devices may be supported.

In most embodiments, system environment 1000 includes a network 1010. Network 1010 may be any type of network familiar to those skilled in the art that can support data communications using any of a variety of commercially-available protocols, including TCP/IP, SNA, IPX, AppleTalk, and the like. Merely by way of example, network 1010 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

System environment 1000 also includes one or more server computers 1012 which may be general purpose computers, specialized server computers (including, merely by way of example, PC servers, UNIX servers, mid-range servers, mainframe computers rack-mounted servers, etc.), server farms, server clusters, or any other appropriate arrangement and/or combination. In various embodiments, server 1002 may be adapted to run one or more services or software applications described in the foregoing disclosure. For example, in one embodiment, server 1012 may act as an enterprise application server configured to execute an enterprise application or one or more other software applications performing the steps of FIGS. 2 and 9.

Server 1012 may run an operating system including any of those discussed above, as well as any commercially available server operating system. Server 1012 may also run any of a variety of additional server applications and/or mid-tier applications, including web servers, FTP servers, CGI servers, Java servers, database servers, and the like. Exemplary database servers include without limitation those commercially available from Oracle, Microsoft, Sybase, IBM and the like.

System environment 1000 may also include one or more databases 1014. Databases 1014 may be configured to store setup data such as business function assignments, service provider-client associations, and procurement-related content, transactional data such as procurement requisitions, and any other type of data described in this disclosure. Databases 1014 may reside in a variety of locations. By way of example, one or more of databases 1014 may reside on a storage medium local to (and/or resident in) one or more of the computers 1002, 1004, 1006, 1008, 1012. Alternatively, databases 1014 may be remote from any or all of the computers 1002, 1004, 1006, 1008, 1012, and/or in communication (e.g., via network 1110) with one or more of these. In one set of embodiments, databases 1014 may reside in a storage-area network (SAN) familiar to those skilled in the art. Similarly, any necessary files for performing the functions attributed to the computers 1002, 1004, 1006, 1008, 1012 may be stored locally on the respective computer and/or remotely, as appropriate. In one set of embodiments, databases 1014 may include relational databases, such as Oracle 10g, that are adapted to store, update, and retrieve data in response to SQL-formatted commands.

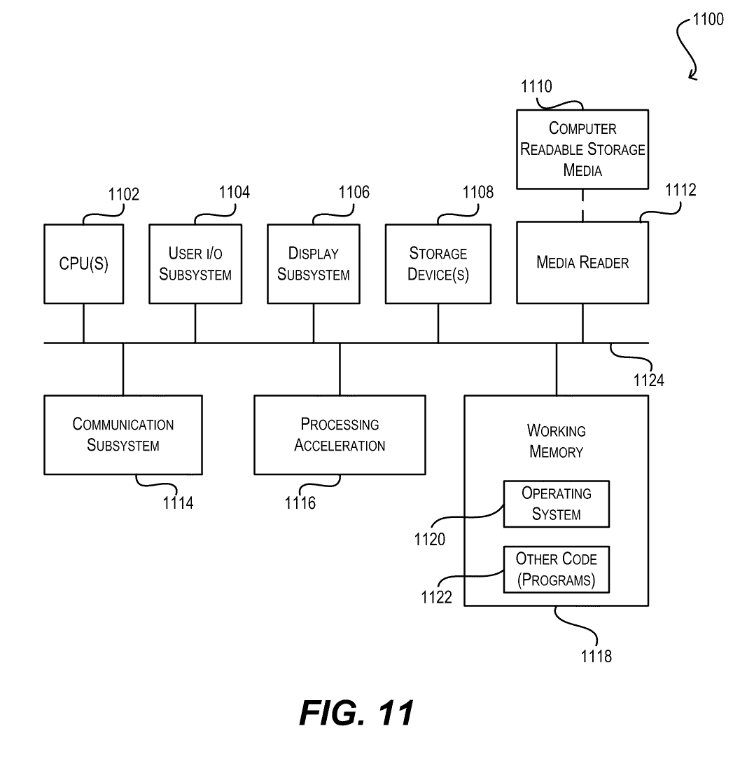

FIG. 11 illustrates a computer system 1100 that may be used in accordance with embodiments of the present invention. In various embodiments, system 1100 may be used to implement any of the computers 1002, 1004, 1006, 1008, 1012 described above. Computer system 1100 is shown comprising hardware elements that may be electrically coupled via a bus 1124. The hardware elements may include one or more central processing units (CPUs) 1102, one or more input devices 1104 (e.g., a mouse, a keyboard, etc.), and one or more output devices 1106 (e.g., a display device, a printer, etc.). Computer system 1100 may also include one or more storage devices 1108. By way of example, the storage device(s) 1108 may include devices such as disk drives, optical storage devices, and solid-state storage devices such as a random access memory (RAM) and/or a read-only memory (ROM), which can be programmable, flash-updateable and/or the like.

Computer system 1100 may additionally include a computer-readable storage media reader 1112, a communications subsystem 1114 (e.g., a modem, a network card (wireless or wired), an infra-red communication device, etc.), and working memory 1118, which may include RAM and ROM devices as described above. In some embodiments, computer system 1100 may also include a processing acceleration unit 1116, which can include a digital signal processor (DSP), a special-purpose processor, and/or the like.

Computer-readable storage media reader 1112 can further be connected to a computer-readable storage medium 1110, together (and, optionally, in combination with storage device(s) 1108) comprehensively representing remote, local, fixed, and/or removable storage devices plus storage media for temporarily and/or more permanently containing computer-readable information. Communications system 1114 may permit data to be exchanged with network 1010 and/or any other computer described above with respect to system environment 1000.

Computer system 1100 may also comprise software elements, shown as being currently located within working memory 1118, including an operating system 1120 and/or other code 1122, such as an application program (which may be a client application, Web browser, mid-tier application, RDBMS, etc.). It should be appreciated that alternative embodiments of computer system 1100 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by a computer.

Although specific embodiments of the present invention have been described, various modifications, alterations, alternative constructions, and equivalents are within the scope of the invention. For example, embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1 A method for supporting shared procurement services, the method comprising:
storing, by a computer system, an association between a first entity and a second entity in an enterprise, the association indicating that the first entity is configured to provide one or more procurement services to the second entity;
storing, by the computer system, procurement-related content generated by the first entity; and
causing, by the computer system, the procurement-related content to be accessible to the second entity based on the association.

2. The method of claim 1 further comprising:
storing, by the computer system, an association between the first entity and a third entity in the enterprise, the association between the first entity and the third entity indicating that the first entity is configured to provide one or more procurement services to the third entity; and
causing, by the computer system, the procurement-related content to be accessible to the third entity based on the association between the first entity and the third entity.

3. The method of claim 1 further comprising:
storing, by the computer system, an association between a third entity in the enterprise and the second entity, the association between the third entity and the second entity indicating that the third entity is configured to provide one or more procurement services to the second entity;
storing, by the computer system, procurement-related content generated by the third entity; and
causing, by the computer system, the procurement-related content generated by the third entity to be accessible to the second entity based on the association between the third entity and the second entity.

4. The method of claim 3 wherein the first entity has a first procurement specialization and the third entity has a second procurement specialization different from the first procurement specialization.

5. The method of claim 4 wherein the first and second procurement specializations correspond to different commodities.

6. The method of claim 4 wherein the first and second procurement specializations correspond to different geographic regions.

7. The method of claim 1 wherein the one or more procurement services include at least one of: supply base management, sourcing, catalog content management, agreement management, and purchase order administration.

8. The method of claim 1 wherein the procurement-related content comprises a purchase agreement negotiated between the first entity and an external supplier.

9. The method of claim 8 wherein the purchase agreement determines whether purchase order administration is performed by the first entity on behalf of the second entity or by the second entity internally.

10. The method of claim 8 wherein the procurement-related content further comprises catalog content and guided templates for off-catalog requisitions.

11. A system for supporting shared procurement services, the system comprising:
a memory component configured to:
store an association between a first entity and a second entity in an enterprise, the association indicating that the first entity is configured to provide one or more procurement services to the second entity; and
store procurement-related content generated by the first entity; and
a processing component in communication with the memory component, the processing component being configured to cause the procurement-related content to be accessible to the second entity based on the association.

12. The system of claim 11 wherein the memory component is further configured to store an association between the first entity and a third entity in the enterprise, the association between the first entity and the third entity indicating that the first entity is configured to provide one or more procurement services to the third entity, and
wherein the processing component is further configured to cause the procurement-related content to be accessible to the third entity based on the association between the first entity and the third entity.

13. The system of claim 11 wherein the memory component is further configured to:
store an association between a third entity in the enterprise and the second entity, the association between the third entity and the second entity indicating that the third entity is configured to provide one or more procurement services to the second entity; and
store procurement-related content generated by the third entity; and
wherein the processing component is further configured to cause the procurement-related content generated by the third entity to be accessible to the second entity based on the association between the third entity and the second entity.

14. The system of claim 13 wherein the first entity has a first procurement specialization and the third entity has a second procurement specialization different from the first procurement specialization.

15. A machine-readable storage medium having stored thereon program code executable by a processing component of a computer system, the program code comprising:
code that causes the processing component to store an association between a first entity and a second entity in an enterprise, the association indicating that the first entity is configured to provide one or more procurement services to the second entity;
code that causes the processing component to store procurement-related content generated by the first entity; and
code that causes the processing component to make the procurement-related content accessible to the second entity based on the association.

16. The machine-readable storage medium of claim 15 wherein the program code further comprises:
code that causes the processing component to store an association between the first entity and a third entity in the enterprise, the association between the first entity and the third entity indicating that the first entity is configured to provide one or more procurement services to the third entity; and
code that causes the processing component to make the procurement-related content accessible to the third entity based on the association between the first entity and the third entity.

17. The machine-readable storage medium of claim 15 wherein the program code further comprises:
code that causes the processing component to store an association between a third entity in the enterprise and the second entity, the association between the third entity and the second indicating that the third entity is configured to provide one or more procurement services to the second entity;
code that causes the processing component to store procurement-related content generated by the third entity; and
code that causes the processing component to make the procurement-related content generated by the third entity accessible to the second entity based on the association between the third entity and the second entity.

18. The machine-readable medium of claim 17 wherein the first entity has a first procurement specialization and the third entity has a second procurement specialization different from the first procurement specialization.
